(19) United States
(12) Patent Application Publication
(10) Pub. No.: US 2006/0281003 A1
(43) Pub. Date: Dec. 14, 2006

(54) OPEN ALKALINE ACCUMULATOR INCLUDING A MICROPOROUS MEMBRANE

(75) Inventors: Georges Caillon, Bruges (FR); Bernard Crochepierre, Saint Medard En Jalles (FR)

Correspondence Address: SUGHRUE MION, PLLC, 2100 PENNSYLVANIA AVENUE, N.W., SUITE 800, WASHINGTON, DC, 20037, US

(73) Assignee: SAFT, Bagnolet (FR)

(21) Appl. No.: 11/421,221

(22) Filed: May 31, 2006

(30) Foreign Application Priority Data
Jun. 2, 2005 (FR) 0505586

(51) Int. Cl. H01M 2/16; H01M 10/44

(52) U.S. Cl. 429/144; 429/254; 429/50

(57) ABSTRACT

The invention proposes an open alkaline accumulator of the nickel cadmium or nickel metal hydride type comprising at least one positive electrode, at least one negative electrode and at least one separator, said separator comprising a microporous membrane of polyolefin grafted with an ethylenically unsaturated monomer, and on either side of said membrane, at least one layer of polyolefin with a fibrous structure. Said accumulator has a lesser risk of thermal runaway upon charging at constant voltage, and a longer life time. The invention lies in the discovery that the use of a microporous membrane of polyolefin grafted with an ethylenically unsaturated monomer in an open alkaline accumulator of the nickel cadmium or nickel metal hydride type, provides a barrier to oxygen gas. The invention is extended to the method for charging at constant voltage said alkaline accumulator.

### TECHNICAL FIELD

The present invention relates to an open alkaline accumulator providing increased safety in the case of it being used while it is charged under a constant voltage, and having a longer lifetime.

### STATE OF THE ART

An open alkaline accumulator of the nickel cadmium or nickel metal hydride type, conventionally comprises:

one or more positive electrodes, the active material of which most often consists of a nickel-based hydroxide Ni(OH)₂,

one or more negative electrodes, the active material of which consists of cadmium in the case of a nickel cadmium accumulator or of hydridable metal in the case of a nickel metal hydride accumulator,

a separator placed between each positive and negative electrode, and

an electrolyte which is a multimolar alkaline solution of a strong base or a mixture of strong bases such as NaOH, KOH or LiOH.

The separator is an electric insulator; it prevents electric contact between a positive electrode and a negative electrode. It has a certain porosity (microporosity) in order to allow the ions of the electrolyte to pass through it.

The accumulator is said to be “open” when the accumulator casing is not sealed and the pressure of the gases in the accumulator is equal to atmospheric pressure, as opposed to a so-called “sealed” accumulator. In a “sealed” alkaline accumulator, the negative electrode is overcapacitive. When the positive electrode is completely charged, the overcharged current causes formation of oxygen therein. The thereby formed oxygen cannot freely escape from the accumulator. It diffuses as a gas towards the negative plate where it is reduced. As the negative electrode is overcapacitive, the sealed accumulator may be overcharged provided that the internal pressure remains sufficiently low.

Charging an open alkaline accumulator under constant voltage without any device for limiting the charge current at the end of charging is not recommended. Indeed, the constant voltage charging method may lead to thermal runaway of the accumulator and to its destruction. Without the intention of being bound by theory, the applicant believes that the mechanism leading to this runaway is the following. When the accumulator approaches the end of charging, and the positive and negative active materials are practically completely charged, a fraction of the charge current is used for forming oxygen at the positive electrode. The oxygen produced at the positive electrode dissolves in the electrolyte and migrates through the separator towards the negative electrode where it is reduced. The current produced by reduction of the oxygen causes a rise in temperature of the accumulator. This rise in temperature causes a reduction of its internal resistance, a reduction in the overpotential for oxygen release at the positive electrode and a reduction in the electromotive force of the accumulator because the open-circuit potential temperature coefficient of an alkaline accumulator is negative. These three concomitant factors have the effect of lowering the potential of the accumulator and therefore of increasing the charging current because the potential applied to the terminals of the accumulator is constant. Increasing the charging current contributes even more to increasing the temperature and thermal runway is thereby activated.

In order to ensure proper operation of the open alkaline accumulator, under charging at constant voltage, the separator should form a barrier to oxygen gas.

The separators used up to now are films of the woven or non-woven, microporous or dense type and may be in nylon (polyamide), cellophane, polypropylene or polyethylene. Some of these films, generally very thin as compared with the others used, may in the initial state have an oxygen barrier property. They are then called membranes. These membranes may have the drawback of deteriorating over time and gradually loosing their oxygen barrier effect. Deterioration of the separator is an important factor in the ageing of the alkaline accumulator. This deterioration is all the faster since the accumulator is used at relatively high temperatures, for example above 40° C.

An open alkaline accumulator is therefore sought after, for which the separator retains its oxygen barrier property, for an operating temperature above 40° C.

### SUMMARY OF THE INVENTION

For this purpose, the invention proposes an open accumulator of the nickel cadmium or nickel metal hydride type comprising at least one positive electrode, at least one negative electrode and at least one separator, said separator comprising a microporous membrane of polyolefin grafted with an ethylenically unsaturated monomer, and on either side of said membrane, at least a polyolefin layer with a fibrous structure. The accumulator according to the invention has a lesser risk of thermal runaway and a longer lifetime.

The invention lies in the discovery that by using a microporous membrane of polyolefin grafted with an ethylenically unsaturated monomer, in an open accumulator with an aqueous electrolyte, it is possible to form a barrier to oxygen gas.

The invention also concerns a the method for charging at constant voltage an open accumulator of the nickel cadmium or nickel metal hydride type comprising at least one positive electrode, at least one negative electrode and at least one separator comprising a microporous membrane of polyolefin grafted with an ethylenically unsaturated monomer.

### SHORT DESCRIPTION OF THE FIGURES

FIG. 1 illustrates a transverse sectional view of an open alkaline accumulator according to the invention.

FIG. 2 illustrates the charging current of open alkaline accumulators versus the charging time at constant voltage expressed as a number of charging days.

Curve A corresponds to an open alkaline accumulator from the prior art, the separator of which consists of a non-grafted microporous membrane positioned between two polyolefin layers with fibrous structure.

Curve B corresponds to an open alkaline accumulator according to the invention, the separator of which comprises a microporous membrane grafted via activation by UV radiation, and positioned between two layers of polyolefin with a fibrous structure.

Curve C corresponds to an open alkaline accumulator which is not part of the invention and the separator of which comprises a dense membrane, grafted via activation by cobalt irradiation, and positioned between two layers of polyolefin with a fibrous structure.

### DETAILED DISCUSSION OF THE EMBODIMENTS OF THE INVENTION

The positive electrode of the accumulator comprises an active electrochemical material which generally is mainly nickel hydroxide Ni(OH)₂, and possibly one or more hydroxides of other compounds such as Zn, Co, Ca, Cd, Mg, Mn, Al, etc., which are syncrystallized with nickel hydroxide.

The negative electrode of the accumulator comprises an active electrochemical material which may be metal cadmium for a nickel cadmium accumulator or a hydridable intermetallic compound of type AB₅, of type AB₂, or of type ABₜ, with 3.2≦t≦3.5 or any standard material in the art. The electrolyte is a concentrated alkaline aqueous solution comprising at least one hydroxide (KOH, NaOH, LiOH), in a concentration which is generally multimolar.

The microporous membrane is in polyolefin, for example in polyethylene or polypropylene, preferably polypropylene. Its total thickness preferably is between 10μm and 50 μm. It includes pores with a diameter preferably between 0.1 μm and 1 μm.

An ethylenically unsaturated monomer is grafted on said polyolefin. Grafting may be activated either by irradiation with a radioactive cobalt emitting γ rays, or by ultraviolet (UV) radiation. The UV radiation method is preferred over the irradiation method because the irradiation method is complex to apply on the one hand, and the membranes of polymers grafted by activation with UV radiation have satisfactory performances at very low temperatures (less than −30° C.), on the other hand. Reference is be made for example to documents U.S. Pat. No. 3,427,206, FR-A-2 489 598, FR-A-2 267 330, FR-A-2 200 305 and FR-A-2 399 134 and to Journal of Applied Polymer Science, Vol. 30, 1023-1033 (1985) for further information on the experimental conditions for applying the irradiation activation method.

The method for activating the grafting of the monomer with UV radiation, comprises the steps, known to one skilled in the art, consisting of:

a) impregnating a microporous polyolefin membrane with a solution of ethylenically unsaturated monomer, b) exposing the impregnated membrane to ultraviolet radiation in an oxygen-free atmosphere.

The ethylenically unsaturated monomers may be carboxylic acids and their esters, such as acrylic acid, methacrylic acid, methyl acrylate and methyl methacrylate. Acrylic acid is preferred. Other vinyl monomers may also be used such as acrylamide, vinyl pyridine, vinyl-pyrrolidone, and styrene-sulfonic acid.

The solvent of the monomer solution is selected so that it does not evaporate significantly during the step b) with emission of UV radiation. The solvent may be water for example.

The monomer solution may possibly contain a homopolymerization inhibitor in order to prevent homopolymerization of the ethylenically unsaturated monomer. A polymerization inhibitor for example may be a salt of copper (II) or a salt of iron (II).

The monomer solution may also contain a surfactant so as to improve the wetting properties of the monomer solution. After exposing the membrane to UV radiation, the latter is washed with deionized water in order to remove the unreacted reagents and homopolymerized acrylic acid which may have formed. The grafted membrane is then dried. Reference is be made for example to documents WO 93/01622 and WO 2004/020730 for further information on the experimental conditions for applying the UV radiation activation method.

The grafted membrane is placed between at least two layers of polyolefin with a fibrous structure in order to form a separator, preferably between two layers of polyolefin with fibrous structure. It is placed out of contact with the positive and negative electrodes. The polyolefin layers placed on either side of the grafted membrane may be in polyamide or polyolefin.

The separator (6) therefore consists of at least three layers, one of which said being grafted microporous membrane that to gives the accumulator a capacity of extended use under charging at a constant voltage. Indeed, the most widespread charging method for this type of accumulators consists in:

a) charging at constant current at the beginning of charging, followed

b) by charging at constant voltage at the end of charging when the voltage of the accumulator reaches a defined plateau value.

The accumulator according to the invention is therefore well suited for operating during step b) of the charging method.

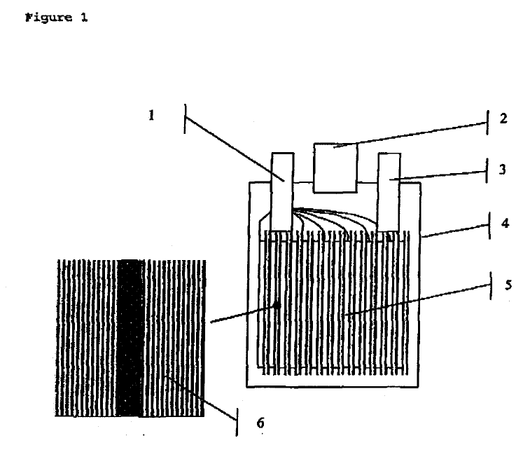

For example, the positive and negative electrodes are made by depositing positive and negative active materials on the planar current collectors. At least one negative electrode, one separator and one positive electrode are superimposed in order to form the electrochemical bundle (5). This bundle is introduced into a plastic casing with a parallelepipedous or prismatic format (4). The positive and negative electrodes are electrically connected to the positive (1) and negative (3) current output terminals, respectively. The casing is filled with electrolyte and then closed with a lid in an unsealed way. This lid may have a safety plug (2). FIG. 1 illustrates a schematic transverse sectional view of an open alkaline accumulator according to the invention.

The accumulator contains electrolyte in excess, i.e., the electrochemical bundle is completely immersed in the electrolyte. The casing is filled with electrolyte so that the level of the electrolyte tops the electrodes and the separators. The invention does not relate to a sealed (or closed) accumulator including a lack of electrolyte. In a sealed accumulator, a portion of the pores of the separator does not contain any electrolyte. The presence of pores which are not filled with electrolyte allows the passage of oxygen through the separator and reduction (or recombination) of the oxygen on the negative electrode. This is specifically what the invention attempts to prevent.

Advantageously, the polyolefin layer with a fibrous structure facing the positive electrode is selected so that its pores have a larger diameter than the diameter of the pores of the grafted membrane. For example, the diameter of the pores of the polyolefin layer with a fibrous structure facing the positive electrode, is larger than 10 microns, for example between 10 and 20 microns, and the diameter of the pores of the grafted membrane is less than 1 micron, for example between 0.1 and 0.5 microns.

It is also advantageous to select the grafted membrane so that its pores have a larger diameter than the diameter of the pores of the polyolefin layer with a fibrous structure facing the negative electrode. Thus, the pore size distribution in the three separator layers follows a decreasing order from the positive electrode to the negative electrode.

The separator and the presence of excess electrolyte have the effect of forming a barrier to the passage of oxygen through the separator. The migration of dissolved oxygen, produced by the positive electrode during the charging, towards the negative electrode is thereby prevented.

An advantage directly related to the oxygen barrier effect is to prevent depolarization of the negative electrode. Depolarization of the negative electrode causes incomplete charging of the accumulator. A second advantage related to the oxygen barrier effect is to reduce the risks of thermal runway of the accumulator. The mechanism was explained earlier.

With the structure of the separator of the accumulator according to the invention, transfer of oxygen through the separator may be avoided in order to prevent thermal runaway. With this structure, the separator may also retain in a stable way its property of forming a barrier to the transfer of oxygen gas in order to prevent thermal runaway. The accumulator according to the invention is particularly very suitable as a power source preferably for aeronautical applications, industrial applications or in telecommunications.

Other features and advantages of the present invention will become apparent upon reading the examples.

### EXAMPLES

Three open alkaline accumulators A, B and C, were assembled and tested.

The accumulator A of the prior art comprises a separator consisting of a non-grafted microporous membrane positioned between two polyolefin layers with a fibrous structure.

The accumulator B according to the invention comprises a microporous membrane of polypropylene grafted via activation with UV radiation, and positioned between two polyolefin layers with a fibrous structure. The grafted membrane is made by grafting with acrylic acid via UV starting with the film 2400 commercially available from Celgard.

The accumulator C, which is not part of the invention, comprises a dense membrane of polyethylene, grafted with acrylic acid via activation by cobalt irradiation, and positioned between two layers of polyolefin with a fibrous structure.

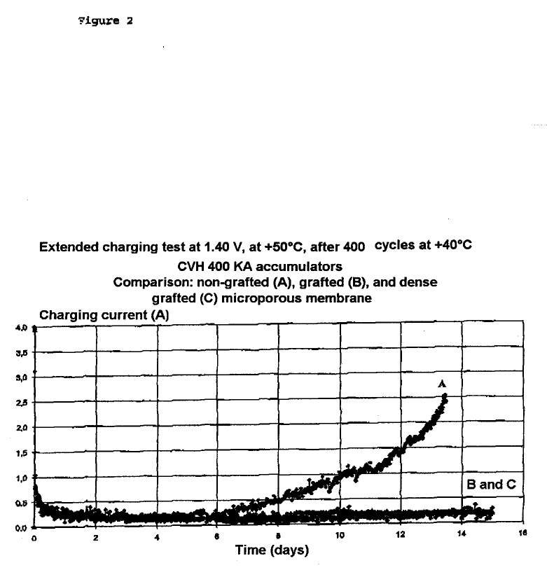

The accumulators A, B and C have first undergone 400 cycles of charging-discharging at a temperature of 40° C., and then they were charged at constant voltage of 1.40 V at a temperature of 50° C. They were maintained in the overcharged state under 1.40 V for several days at 50° C. The change in the charging current was measured versus the number of charging days. This change is illustrated in FIG. 2.

The charging current of the accumulator A is from about 0.25 A up to the 6^{th} charging day, and then increases from the 6^{th} day, reaching 2.5 A at the 13^{th} day. The increase in the charging current on the 6^{th} day is explained by deterioration of the oxygen barrier property of the separator. The charging of the accumulator A had to be stopped on the 13^{th} day in order to avoid onset of thermal runaway.

Indeed, for a charging current of 2.5 A and a charging voltage of 1.40 V, the accumulator dissipates a heat power of 3.5 W. From the knowledge that the mass of a test accumulator is about 1 kg and that its mass heat capacity is 1.25 J/g/° C., it is inferred that the rise in temperature of the accumulator is about 10° C./hr. Under such conditions, charging should be interrupted or else the accumulator may be destroyed.

On the contrary, the charging current of accumulators B and C remains constant at about 0.25 A after 15 days of charging at constant voltage. The accumulators B and C may therefore operate during charging at constant voltage for an extended period. The separator of the B and C accumulators forms a barrier to oxygen gas.

The present embodiment and the figures should be considered as having been presented as an illustration and not as a restriction, and the invention is not supposed to be limited to the details provided here but may be altered while remaining within the scope of the appended claims.

1. An open accumulator of the nickel cadmium or nickel metal hydride type comprising an electrolyte, at least one positive electrode, at least one negative electrode and at least one separator, said separator comprising a microporous membrane of polyolefin grafted with an ethylenically unsaturated monomer, and on either side of said membrane, at least one layer of polyolefin with a fibrous structure.

2. The open accumulator according to claim 1, wherein the electrolyte is in excess.

3. The open accumulator according to claim 1, wherein the microporous polyolefin membrane is placed between two layers of polyolefin with a fibrous structure.

4. The open accumulator according to claim 3, wherein the diameter of the pores of the polyolefin layer with a fibrous structure, facing the positive electrode, is larger than the diameter of the pores of the grafted membrane.

5. The open accumulator according to claim 4, wherein the diameter of the pores of the polyolefin layer with a fibrous structure facing the positive electrode, is larger than 10 microns, and the diameter of the pores of the grafted membrane is less than 1 micron.

6. The open accumulator according to claim 5, wherein the diameter of the pores of the grafted membrane is between 0.1 microns and 1 micron.

7. The open accumulator according to claim 3, wherein the pores of the grafted membrane have a diameter larger than the diameter of the pores of the polyolefin layer with a fibrous structure facing the negative electrode.

8. The open accumulator according to claim 1, wherein the ethylenically unsaturated monomer is a carboxylic acid.

9. The open accumulator according to claim 8, wherein the carboxylic acid is acrylic acid.

10. The open accumulator according to claim 1, wherein the polyolefin is polyethylene or polypropylene, preferably polypropylene.

11. The open accumulator according to claim 1, wherein the thickness of the membrane is between 10 μm and 50 μm.

12. The open accumulator according to claim 1, wherein the grafting of the polyolefin was activated with UV radiation.

13. The use of a microporous membrane of polyolefin grafted with an ethylenically unsaturated monomer, in an open accumulator of the nickel cadmium or nickel metal hydride type, in order to form a barrier to oxygen gas.

14. A method for charging at a constant voltage an open accumulator of the nickel cadmium or nickel metal hydride type comprising at least one positive electrode, at least one negative electrode and at least one separator, comprising a microporous membrane of polyolefin, grafted with an ethylenically unsaturated monomer.

15. The charging method according to claim 14, wherein the accumulator is an open accumulator of the nickel cadmium or nickel metal hydride type comprising an electrolyte, at least one positive electrode, at least one negative electrode and at least one separator, said separator comprising a microporous membrane of polyolefin grafted with an ethylenically unsaturated monomer, and on either side of said membrane, at least one layer of polyolefin with a fibrous structure.

16. The charging method according to claim 14 or 15, wherein the charging is performed at a temperature above 40° C.

17. The charging method according to claim 15, wherein the charging is performed at a temperature above 40° C.
